(19) United States
(12) Patent Application Publication
(10) Pub. No.: US 2008/0127559 A1
(43) Pub. Date: Jun. 5, 2008

(54) Closure Means

(76) Inventor: Brian Gay, Patterson Lakes (AU)

Correspondence Address: Ralph A. Dowell of DOWELL & DOWELL P.C., 2111 Eisenhower Ave, Suite 406, Alexandria, VA, 22314, US

(21) Appl. No.: 11/885,959

(22) PCT Filed: Mar. 10, 2006
(86) PCT No.: PCT/AU06/00306

§ 371 Date: Feb. 11, 2008

(30) Foreign Application Priority Data
Mar. 11, 2005 (AU) 2005901200

(51) Int. Cl. E05D 15/48

(52) U.S. Cl. 49/149

(57) ABSTRACT

A door assembly (2) adapted to be mounted on a surface (2), the surface having an aperture (4), the door (6) being of a size sufficient to completely cover the aperture (4), the assembly (2) including means for increasing a length of the aperture along a first axis or means for decreasing the length of the door (6) along a first axis, means for altering the position of the door (6) either laterally or longitudinally relative to the aperture (4), means for allowing the door (6) to pivot on a second axis and means for allowing the door hinge relative to the aperture (4) wherein the operation of door (6) is capable of passing through the aperture (4) by increasing a length of the aperture (4) along the first axis or decreasing the length of the door (6) along the first axis, altering the position of the door (6) laterally or longitudinally, and pivoting the door (6) on the second axis.

### FIELD OF THE INVENTION

The present invention relates to doors that are capable of forming a substantially water tight or gas tight seal against a surface. More particularly, the invention provides a door that is able to form a seal against a surface while retaining the capacity to swing both inwardly and outwardly.

### BACKGROUND

A simple and economical type of door that is able to seal is known in the art. This type of door is larger than the aperture for which it is designed to seal, such that there is a border region around the aperture where the door makes sealing contact with the aperture surrounds. Typically, the door is used on a vessel to retain water, the door being mounted inside the vessel. When the vessel is filled with water a seal is created by the exertion of hydrostatic pressure from inside the vessel pushing the door firmly against the aperture surrounds thereby creating a seal. Typically, there is a tract of rubber or silicone around the aperture to ensure a good seal. Thus, the door seals only when it is necessary, that is when there is fluid inside the vessel.

A problem arises with this type of door in that it is not possible to open the door in an outwards direction due to the fact that the door is by necessity larger than the aperture to which it is fitted. This is an undesirable situation to which, to the best of the Applicant's knowledge, the prior art has provided no simple solution.

It is an aspect of the present invention to provide a door and hinge assembly that allows a door that is larger than the aperture to which it is fitted is able to pass through that aperture. This capability permits the door to swing in an outwards direction.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed in Australia before the priority date of each claim of this application.

### IN THE FIGURES

FIG. 1 illustrates a lateral view of the assembly as mounted on a surface.

FIG. 2 illustrates a plan view of the assembly as shown in FIG. 1.

### SUMMARY OF THE INVENTION

In a first aspect the present invention provides a door assembly adapted to be mounted on a surface, the surface having an aperture, the door being of a size sufficient to completely cover the aperture, the assembly including means for increasing a length of the aperture along a first axis or means for decreasing the length of the door along a first axis, means for altering the position of the door either laterally or longitudinally relative to the aperture, means for allowing the door to pivot on a second axis, and means for allowing the door to hinge relative to the aperture, wherein in operation the door is capable of passing through the aperture by increasing a length of the aperture along the first axis or decreasing the length of the door along the first axis, altering the position of the door laterally or longitudinally, and pivoting the door on the second axis.

Applicants have provided a solution to the problem of being unable to outwardly open a door that is larger than the aperture to which it is fitted. Where this contrivance is used on a hydrotherapy vessel, the advantage is noted where the user of the vessel loses consciousness and slumps against the door. Since in prior art vessels the door cannot be opened inwards, use of the present invention allows the door to open outwards, thereby providing access to the unconscious user. A further advantage is seen where the hydrotherapy vessel includes a large piece of exercise equipment such as a bicycle in which case the door is also prevented from opening inwards.

Reference to “a length” of the aperture is intended to also include a width of the aperture. A length of the aperture may be increased in a number of ways such as by folding away a hingedly attached portion of the structure in which the aperture resides, or alternatively by removing a removable panel in the structure. Alternatively (and where the aperture is rectangular for example) the length of the aperture may be increased infinitely such that the aperture consists only of three edges. In certain situations this may even be necessary to allow other structures associated with the door (such as the hinge) to swing outwards with the door. In a preferred form of the invention a length of the aperture is increased by removing a removable panel normal present on an edge of the aperture. Preferably the removable panel is removed from an upper edge of the aperture.

The net effect of increasing a length or width of the aperture is to remove an impediment to the door passing through the aperture in one dimension (i.e. length or width).

The means for laterally or longitudinally adjusting the door relative to the aperture may be located on the door, hinge, aperture or surface or a combination of any of these. The means may simply be the door itself such that the user grasps the door and adjusts its position up or down, left or right directly. The means may be a handle attached to the door that may be grasped by the user to assist in adjusting the door. Alternatively, the means for adjusting the position of the door could be a lever attached to a surface that actuates against the door, or it may be a lever attached to the door that actuates against a surface. In a preferred form of the invention the means is a lever that actuates against the central spindle of the hinge. Since the spindle of the hinge is in contact with the door, the door moves in concert with the spindle. The lift may be actuated by a spring or by an electric servo motor for example. The skilled person will be amply enabled to conceive of other means for adjusting the position of the door and all are included herein.

The pivot means may be any contrivance that allows the door to pivot along an axis. Preferably the pivot means is a swivel joint mounted on an upper edge of the door. Preferably the pivot means is located on a central axis of the door. The pivot may allow the door to pivot horizontally or vertically, but preferably it allows vertical pivoting.

Typically, but not necessarily the first axis is substantially perpendicular to the second axis.

While the invention has been described by assuming that both door and aperture are rectangular, the skilled artisan will be able to apply the general principles described herein to other geometric shapes such as circles, diamonds, squares, triangles and even irregular shapes.

The invention will now be described by reference to the non-limiting figures.

### DETAILED DESCRIPTION OF A PREFERRED EMBODIMENT OF THE INVENTION

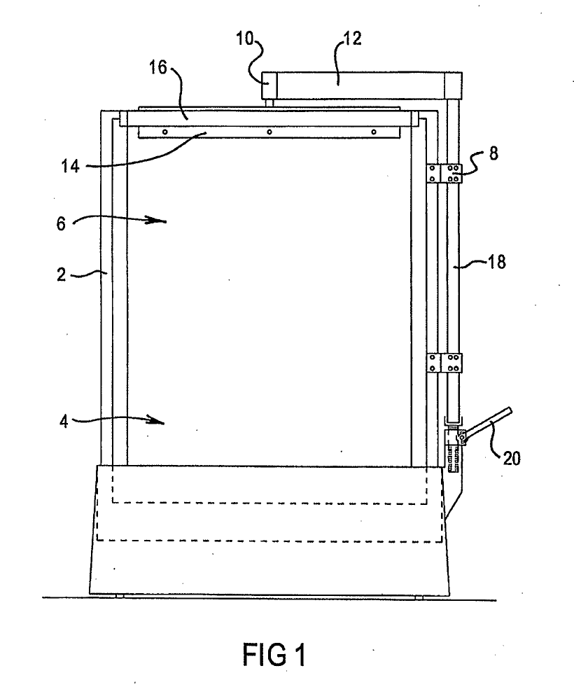

An exemplary embodiment of the apparatus for providing a hydrotherapy vessel is shown generally in FIG. 1. The assembly is mounted on a surface shown generally at 2, having an aperture 4. The door 6 is mounted on a hinge 8 such that the door 6 is able to move in an upwards direction. The hinge 8 is attached to a swivel joint 10 by a cross member 12. The door 6 is fitted with a steel plate fabricated channel 14 to which a removable panel 16 is attached. The hinge spindle 18 is fitted with a lever lift 20.

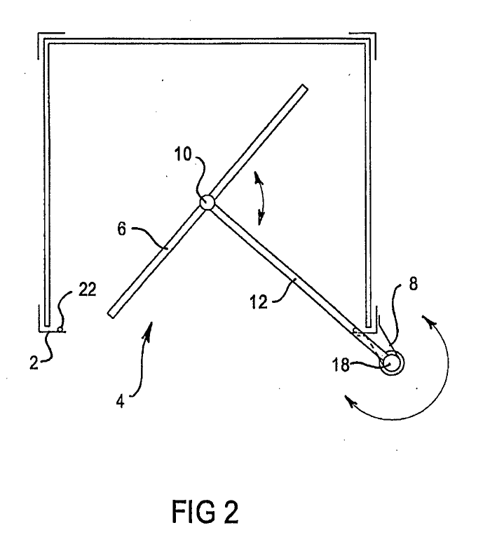

The plan view of FIG. 2 shows additionally the rubber seal 22 against which the door 6 abuts to create the seal when in the closed position.

In the closed position the removable panel 16 is in place to form the aperture 4. If it is necessary to open the door outwards then the removable panel 16 is removed to leave a lengthened aperture. The door will still not swing outwards however because, in part, the lower edge of the door is still in contact with the lower lip of the aperture. To correct this, the lift 20 is actuated to raise the door 6 just enough so that the lower edge of the door now clears the lower lip of the aperture, but not so much that the upper edge of the door contacts any other superior structure. After this step of raising the door 6, the door 6 is pivoted on its longitudinal axis by the swivel joint 10 such that the entire door can now pass through the aperture.

It is contemplated that the skilled person will be able to conceive of alternative apparatus and methods for implementing the invention described herein. Such alternative methods are considered to fall within the scope of the invention described herein.

1-12. (canceled)

13. A door assembly adapted to be mounted on a surface, the surface having an aperture, the door being of a size sufficient to completely cover the aperture, the assembly including means for increasing a length of the aperture along a first axis or means for decreasing the length of the door along a first axis, means for altering the position of the door laterally or longitudinally relative to the aperture, means for allowing the door to pivot on a second axis, and means for allowing the door to hinge relative to the aperture, wherein in operation the door is capable of passing through the aperture by increasing a length of the aperture along the first axis or decreasing the length of the door along the first axis, altering the position of the door laterally or longitudinally, and pivoting the door on the second axis.

14. A door assembly according to claim 13 wherein the door is larger than the aperture to which it is to be fitted.

15. A door assembly according to claim 14 wherein the door and/or aperture is/are fitted with a seal such that a substantially watertight seal is capable of being formed between the door and the aperture.

16. A door assembly according to claim 13 capable of being used to retain water in a substantially watertight vessel.

17. A door assembly according to claim 16 wherein the door is capable of being opened in an outwards direction from the vessel.

18. A door assembly according to claim 13 wherein the length of the aperture is increased by removing a removable panel normally present on an edge of the aperture.

19. A door assembly according to claim 18 wherein the removable panel is removed from an upper edge of the aperture.

20. A door assembly according to claim 13 wherein the means for laterally or longitudinally adjusting the door relative to the aperture is a lever capable of actuating on the door, the door hinge, or any structure attached to the door or the door hinge.

21. A door assembly according to claim 13 wherein the pivot means is a swivel joint mounted on an upper edge of the door.

22. A door assembly according to claim 13 wherein the pivot means is located on a central axis of the door.

23. A door assembly according to claim 13 wherein the pivot means allows the door to pivot vertically.

24. A door assembly according to claim 13 wherein the first axis is substantially perpendicular to the second axis.
